(19) United States
(12) Patent Application Publication
(10) Pub. No.: US 2023/0387735 A1
(43) Pub. Date: Nov. 30, 2023

(54) COOLING OF AXIAL FLUX MOTOR WITH STATOR COOLANT CHANNEL

(71) Applicant: GM GLOBAL TECHNOLOGY OPERATIONS LLC, DETROIT, MI (US)

(72) Inventors: SeungHwan Keum, Northville, MI (US); Jian Yao, Shanghai (CN); Anthony Michael Coppola, Rochester Hills, MI (US)

(21) Appl. No.: 17/847,705

(22) Filed: Jun. 23, 2022

(30) Foreign Application Priority Data
May 31, 2022 (CN) 202210604100.X

(51) Int. Cl. H02K 1/20; H02K 3/24; H02K 5/20; H02K 15/02; H02K 15/12

(52) U.S. Cl. CPC H02K 1/20; H02K 3/24; H02K 5/203; H02K 15/02; H02K 15/12

(57) ABSTRACT

A stator of an electric machine includes a stator core and a plurality of electrically conductive windings secured to the stator core. A volume of potting material supports the plurality of electrically conductive windings at the stator core. One or more stator coolant channels are defined in the volume of potting material configured to convey a flow of stator coolant therethrough to remove heat from the plurality of electrically conductive windings. A method of forming a stator of an electric machine includes arranging a plurality of electrically conductive windings on a stator core, applying a volume of potting material to the plurality of electrically conductive windings, and defining one or more stator coolant channels in the volume of potting material. The one or more stator coolant channels are configured to convey a flow of stator coolant therethrough to remove heat from the plurality of electrically conductive windings.

### CROSS REFERENCE TO RELATED APPLICATIONS

This application claims the benefit of Chinese Application No. 202210604100.X filed on May 31, 2022, the disclosure of which is incorporated herein by reference in its entirety.

### INTRODUCTION

The subject disclosure relates to electric machines, and in particular to the cooling of electric machines.

In one type of electrical motor, an axial flux motor, the rotor and stator are arranged in a stack along a machine axis, and an axial-directed magnetic flux between the stator and rotor drives rotation of the rotor about the machine axis. The conductive windings of the stator are potted in an epoxy material to provide structural support for the windings. The windings generate heat during operation of the motor, and require cooling to ensure safe and efficient operation. Cooling channels are typically provided in the motor case in which the rotor and stator reside, but the epoxy material used as potting has very low thermal conductivity and is ineffective in removing heat from the windings, and effectively acts as a thermal insulator of the windings. This limits the effectiveness of the case cooling channels.

### SUMMARY

In one embodiment, a stator of an electric machine includes a stator core, a plurality of electrically conductive windings secured to the stator core, and a volume of potting material to support the plurality of electrically conductive windings at the stator core. One or more stator coolant channels are defined in the volume of potting material to convey a flow of stator coolant therethrough to remove heat from the plurality of electrically conductive windings.

Additionally or alternatively, in this or other embodiments the one or more stator coolant channels contact the plurality of electrically conductive windings.

Additionally or alternatively, in this or other embodiments the volume of potting material is an epoxy material.

Additionally or alternatively, in this or other embodiments the one or more stator coolant channels extend circumferentially around the stator.

Additionally or alternatively, in this or other embodiments an arrangement of sacrificial material is embedded in the volume of potting material to define to define the one or more stator coolant channels. The one or more stator coolant channels are formed by removal of the sacrificial material.

Additionally or alternatively, in this or other embodiments the sacrificial material is removed by one or more of combusting, heating or dissolving the sacrificial material.

Additionally or alternatively, in this or other embodiments the flow of stator coolant in electrically nonconductive.

In another embodiment, an electric machine includes a rotor, and a stator electromagnetically interactive with the rotor to drive rotation of the rotor about a central axis. The stator includes a stator core, a plurality of electrically conductive windings secured to the stator core, and a volume of potting material to support the plurality of electrically conductive windings at the stator core. One or more stator coolant channels are defined in the volume of potting material configured to convey a flow of stator coolant therethrough to remove heat from the plurality of electrically conductive windings.

Additionally or alternatively, in this or other embodiments the one or more stator coolant channels contact the plurality of electrically conductive windings.

Additionally or alternatively, in this or other embodiments the volume of potting material is an epoxy material.

Additionally or alternatively, in this or other embodiments the one or more stator coolant channels extend circumferentially around the stator.

Additionally or alternatively, in this or other embodiments an arrangement of sacrificial material is embedded in the volume of potting material to define to define the one or more stator coolant channels. The one or more stator coolant channels are formed by removal of the sacrificial material.

Additionally or alternatively, in this or other embodiments the sacrificial material is removed by one or more of combusting, heating or dissolving the sacrificial material.

Additionally or alternatively, in this or other embodiments the rotor and the stator are located in a machine housing.

Additionally or alternatively, in this or other embodiments one or more housing coolant channels are defined in the machine housing.

Additionally or alternatively, in this or other embodiments the electric machine is an axial flux electric machine.

In yet another embodiment, a method of forming a stator of an electric machine includes arranging a plurality of electrically conductive windings on a stator core, applying a volume of potting material to the plurality of electrically conductive windings, and defining one or more stator coolant channels in the volume of potting material. The one or more stator coolant channels are configured to convey a flow of stator coolant therethrough to remove heat from the plurality of electrically conductive windings.

Additionally or alternatively, in this or other embodiments a first portion of the volume of potting material is applied, a sacrificial material is arranged on the first portion of the volume of potting material, a second portion of the volume of potting material is applied, and the sacrificial material is removed to define the one or more stator coolant channels.

Additionally or alternatively, in this or other embodiments the sacrificial material is removed by one or more of combusting, heating or dissolving the sacrificial material.

Additionally or alternatively, in this or other embodiments the one or more stator coolant channels contact the plurality of electrically conductive windings.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a partial perspective view of an embodiment of an electric machine;

FIG. 2 is a perspective view of an embodiment of a stator of the electric machine of FIG. 1;

FIG. 3 is a sectional view of an embodiment of a stator of an electric machine;

FIG. 4 is an enlarged cross-sectional view of an embodiment of an electric machine taken at circle 4 of FIG. 3;

FIG. 5 is a schematic illustration of a method of forming a stator;

FIG. 6 is a perspective view of a stator having a first portion of potting material installed to the stator;

FIG. 7 is a perspective view of a stator having a sacrificial material defining one or more stator coolant pathways installed to the stator; and

FIG. 8 is a perspective view illustrating a second portion of potting material enclosing the sacrificial material.

### DETAILED DESCRIPTION

The following description is merely exemplary in nature and is not intended to limit the present disclosure, its application or uses. It should be understood that throughout the drawings, corresponding reference numerals indicate like or corresponding parts and features.

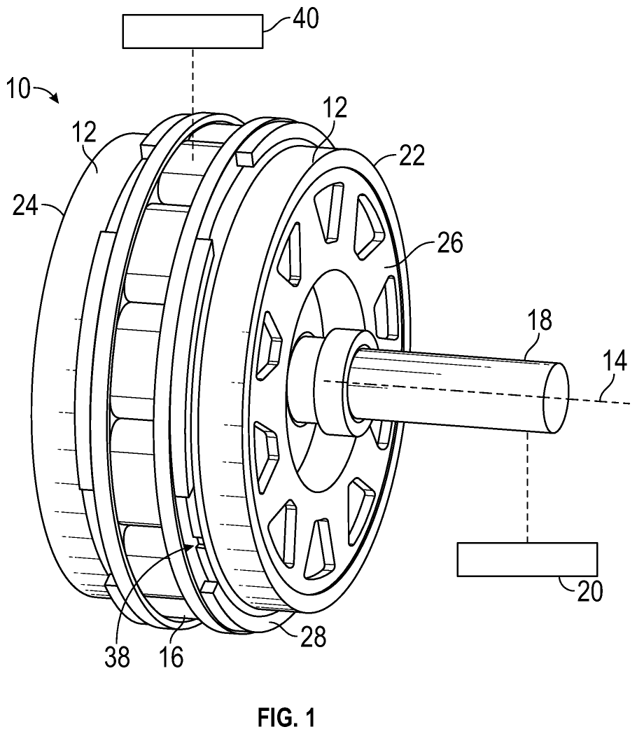

Illustrated in FIG. 1 is an embodiment of an electric motor 10, in particular an axial-flux electric motor 10. The electric motor 10 includes a rotor 12 located on a machine central axis 14, and rotatable about the central axis 14, and a stator 16 which when energized is electromagnetically interactive with the rotor 12, causing rotation of the rotor 12 about the central axis 14. The rotor 12 is operably connected to a rotor shaft 18, which is driven in rotation about the central axis 14 by the rotation of the rotor 12. The rotational energy of the rotor shaft 18 may be used to drive one or more components 20 or systems operably connected to the rotor shaft 18, either directly or indirectly.

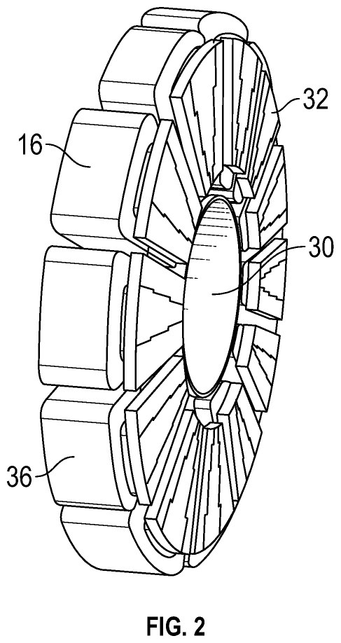

In the electric motor 10 of FIG. 1, the rotor 12 includes a first rotor element 22 located at a first axial side of the stator 16, and a second rotor element 24 located at a second axial side of the stator 16, opposite the first axial side. Each rotor element 22, 24 includes a rotor core 26 and a plurality of permanent magnets 28 arranged in the rotor core 26. The stator 16 is located on the central axis 14, axially between the first rotor element 22 and the second rotor element 24. Referring now to FIG. 2, an exemplary stator 16 is illustrated. The stator 16 includes a stator core 30 and a plurality of conductive windings 32 arranged about the stator core 30. A volume of potting material 36, such as an epoxy material is added to the stator 16 to provide structural support for the conductive windings 32 about the stator core 30.

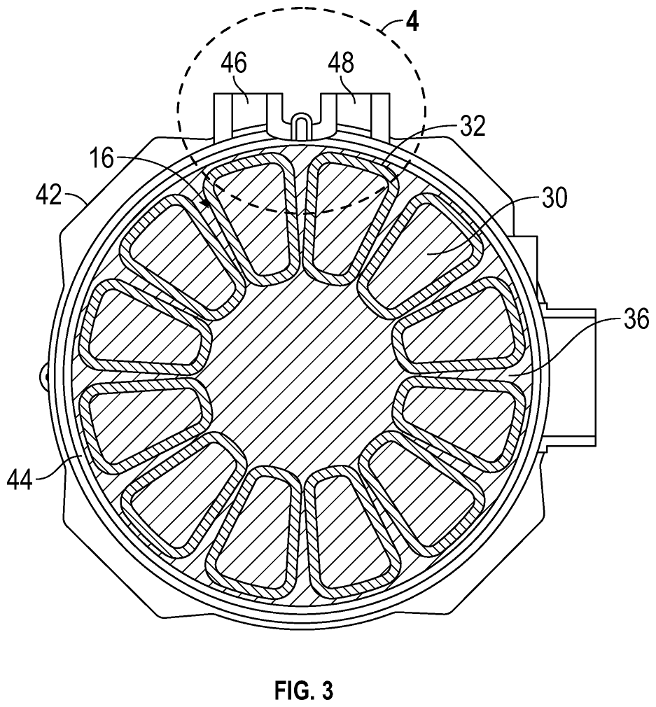

Referring again to FIG. 1, the stator 16 and the rotor elements 22, 24 are arranged along the central axis 14 with an axial air gap 38 between the stator 16 and the respective adjacent rotor element 22, 24. The conductive windings 32 of the stator core 30 are connected to an electrical power source 40. When the conductive windings 32 are energized from the electrical power source 40, the magnetic flux of the energized conductive windings 32 interacts with the rotor permanent magnets 28 across the air gap 38 to drive rotation of the rotor 12 about the central axis 14. Referring now to FIG. 3, the rotor 12 and the stator 16 are disposed in a motor housing 42 that extends circumferentially around the rotor 12 and the stator 16. The stator 16 is rotationally fixed relative to the motor housing 42, and in some embodiments is secured to the motor housing 42. One or more housing cooling channels 44 are formed in the motor housing 42, and extend from a channel inlet 46 to a channel outlet 48. A coolant, such as a glycol coolant or the like, is flowed through the one or more housing cooling channels 44 to remove thermal energy from the electric motor 10.

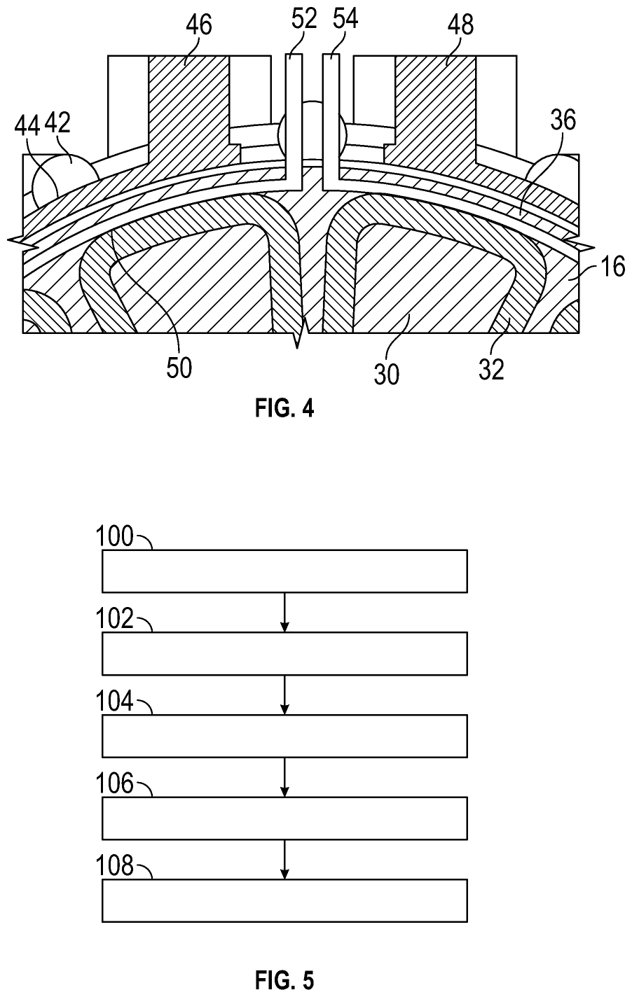

Referring now to FIG. 4, the stator 16 includes features to remove additional thermal energy from the conductive windings 32. One or more stator coolant channels 50 are formed in the potting material 36, and in some embodiments are in direct contact with the conductive windings 32. The stator coolant channels 50 extend from a stator coolant inlet 52 to a stator coolant outlet 54, and a stator coolant flows through the stator coolant channels 50 to remove thermal energy from the conductive windings 32. The stator coolant is a non-electrically conductive fluid such as automatic transmission fluid (ATF) for a vehicle or the like. The stator coolant channels 50 allow for direct cooling of the conductive windings 32, thus improving the efficiency of cooling of the stator 16, and of the electric motor 10 as a whole.

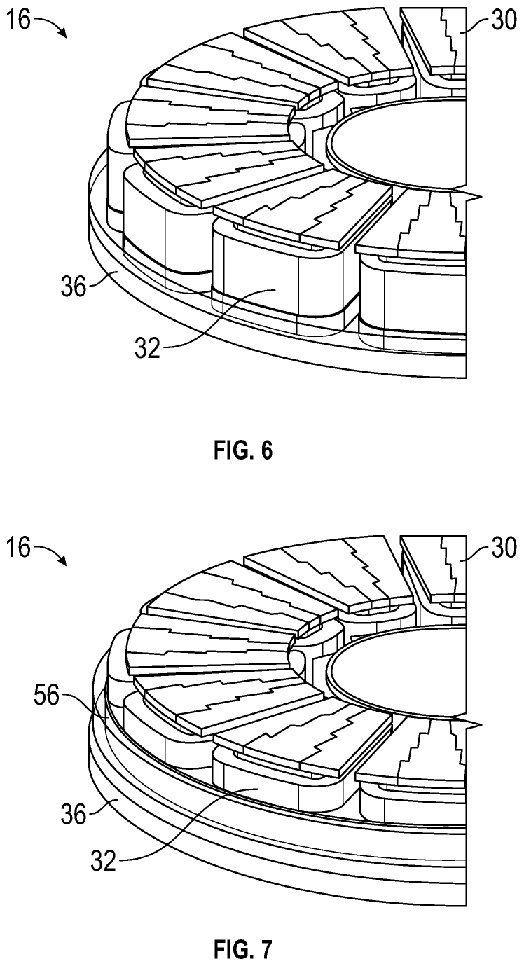

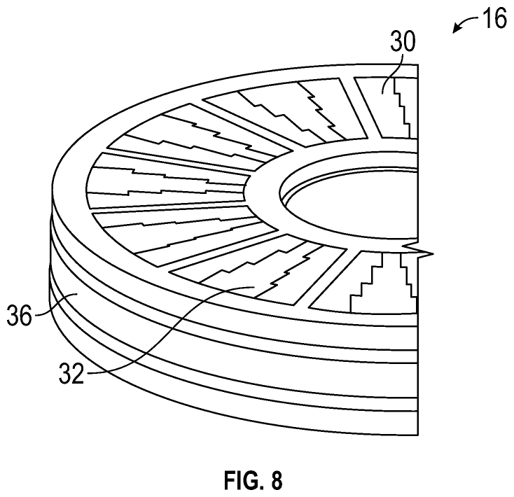

Referring now to FIGS. 5-8, an embodiment of a method of forming a stator 16 including the stator cooling channels 50 will be described. First, the conductive windings 32 are installed to the stator core 30 at step 100, as shown in FIG. 5. A multi-stage potting material 36 follows, in which a first portion of the volume of potting material 36 is installed to the stator 16 at step 102, as also shown in FIG. 6. Next, at step 104 and also as shown in FIG. 7, a sacrificial material 56 is installed to the stator 16. The sacrificial material 56 defines the path of the stator coolant channels 50. A second portion of the volume of potting material 36 is then installed at step 106, as also shown in FIG. 8, enclosing the volume of sacrificial material 56. At step 108, the sacrificial material 56 is removed from the stator 16, leaving the stator cooling channels 50 defined in the volume of potting material 36. While a first portion and a second portion of the volume of potting material 36 are described herein, one skilled in the art will readily appreciate that additional portions of the volume of potting material 36 may be utilized in forming the stator 16.

The sacrificial material 56 may be, for example, a combustible sacrificial material 56, which is removed by combusting the sacrificial material 56 and expelling an exhaust gas of the combustion from the stator cooling channels 50. The sacrificial material 56 may be a thermally depolymerizable or meltable material such as a low melting temperature alloy or polymer, such as a wax or paraffin material. Such sacrificial materials 56 are removed by applying heat to the stator 16 thus melting the sacrificial material 56, which may be pouted out or otherwise removed from the stator cooling channels 50. In other embodiments the sacrificial material 56 is a water soluble material, which may be remove by flushing the stator cooling channels 50 with water thus dissolving and removing the sacrificial material 56 and leaving the stator cooling channels 50.

The stator 16 configurations described herein including the stator cooling channels 50 embedded in the volume of potting material 36 in the stator 16 greatly improves the cooling efficiency of the stator 16, thus improving the performance of the electric machine 10. This is achieved by increasing the flow of coolant medium around the conductive windings 32, and also bringing the flow of stator coolant closer to, and in some embodiments into direct contact with the conductive windings 32 to improve cooling of the conductive windings 32.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A stator of an electric machine comprising:
a stator core;
a plurality of electrically conductive windings secured to the stator core;
a volume of potting material to support the plurality of electrically conductive windings at the stator core; and
one or more stator coolant channels defined in the volume of potting material configured to convey a flow of stator coolant therethrough to remove heat from the plurality of electrically conductive windings.

2. The stator of claim 1, wherein the one or more stator coolant channels contact the plurality of electrically conductive windings.

3. The stator of claim 1, wherein the volume of potting material is an epoxy material.

4. The stator of claim 1, wherein the one or more stator coolant channels extend circumferentially around the stator.

5. The stator of claim 1, further comprising an arrangement of sacrificial material embedded in the volume of potting material to define to define the one or more stator coolant channels, wherein the one or more stator coolant channels are formed by removal of the sacrificial material.

6. The stator of claim 5, wherein the sacrificial material is removed by one or more of combusting, heating or dissolving the sacrificial material.

7. The stator of claim 1, wherein the flow of stator coolant is electrically nonconductive.

8. An electric machine, comprising:
a rotor;
a stator electromagnetically interactive with the rotor to drive rotation of the rotor about a central axis, the stator including:
a stator core;
a plurality of electrically conductive windings secured to the stator core;
a volume of potting material to support the plurality of electrically conductive windings at the stator core; and
one or more stator coolant channels defined in the volume of potting material configured to convey a flow of stator coolant therethrough to remove heat from the plurality of electrically conductive windings.

9. The electric machine of claim 8, wherein the one or more stator coolant channels contact the plurality of electrically conductive windings.

10. The electric machine of claim 8, wherein the volume of potting material is an epoxy material.

11. The electric machine of claim 8, wherein the one or more stator coolant channels extend circumferentially around the stator.

12. The electric machine of claim 8, further comprising an arrangement of sacrificial material embedded in the volume of potting material to define to define the one or more stator coolant channels, wherein the one or more stator coolant channels are formed by removal of the sacrificial material.

13. The electric machine of claim 12, wherein the sacrificial material is removed by one or more of combusting, heating or dissolving the sacrificial material.

14. The electric machine of claim 8, wherein the rotor and the stator are located in a machine housing.

15. The electric machine of claim 14, further comprising one or more housing coolant channels defined in the machine housing.

16. The electric machine of claim 8, wherein the electric machine is an axial flux electric machine.

17. A method of forming a stator of an electric machine comprising:
arranging a plurality of electrically conductive windings on a stator core;
applying a volume of potting material to the plurality of electrically conductive windings; and
defining one or more stator coolant channels in the volume of potting material, the one or more stator coolant channels configured to convey a flow of stator coolant therethrough to remove heat from the plurality of electrically conductive windings.

18. The method of claim 17, further comprising:
applying a first portion of the volume of potting material;
arranging a sacrificial material on the first portion of the volume of potting material;
applying a second portion of the volume of potting material; and
removing the sacrificial material to define the one or more stator coolant channels.

19. The method of claim 18, wherein the sacrificial material is removed by one or more of combusting, heating or dissolving the sacrificial material.

20. The method of claim 17, wherein the one or more stator coolant channels contact the plurality of electrically conductive windings.
